(19) United States
(12) Patent Application Publication
(10) Pub. No.: US 2015/0032590 A1
(43) Pub. Date: Jan. 29, 2015

(54) APPARATUS AND A METHOD FOR CREATING A HIGH SPEED FINANCIAL MARKET DATA MESSAGE STREAM

(71) Applicant: The NASAQ OMX Group, Inc., New York, NY (US)

(72) Inventors: Thomas FAY, New York, NY (US); Dominick PANISCOTTI, New York, NY (US)

(73) Assignee: The NASDAQ OMX Group, Inc., New York, NY (US)

(21) Appl. No.: 13/950,680

(22) Filed: Jul. 25, 2013

(51) Int. Cl. G06Q 40/04

(52) U.S. Cl. CPC G06Q 40/04
USPC 705/37

(57) ABSTRACT

A matching engine message stream generator of an electronic exchange platform generates protocol-specific market data messages use and includes a first interface created on a reconfigurable logic device that receives matching engine message(s) with a source specific format from a matching engine. Based on a set of pre-defined conditions, the first interface filters out and discards messages of source specific format. The message stream generator further includes a buffer on the logic device that stores undiscarded messages of source specific format. The message stream generator also includes logic on the logic device that converts stored message(s) in source specific format into a market data message in a standardized format and generates a stream of market data messages having that standardized format. The message stream generator includes a second interface on the logic device that transmits the stream of converted market data messages.

### TECHNICAL FIELD

Embodiments of the invention presented herein generally relate to the creation of a specific type of data that is utilized by securities markets and its connected members. In particular, embodiments of the present invention relate to methods and apparatuses for creating a high speed market data message feed.

### BACKGROUND

This section is intended to provide a background to the various embodiments of the present invention that are described in this disclosure. The description herein may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

An automated exchange typically receives order input data, in the form of data messages, from external devices used by traders, or brokers. The traders, or brokers, submit orders and/or quotes (or alterations/cancellations thereof) to the automated exchange for purposes of trading. In this context, an order is a request to sell or buy a financial instrument from any trading participant of the automated exchange and a “quote” may be an “offer” price, a “bid” price, or a combination of both an “offer” and “bid” price of a financial instrument, and is determined from quotations made by trading participants (or dealers).

As can be seen from the above, data transmission between external devices connected to the exchange and vice versa constitutes an important aspect of the electronic communication between related parties. Efficient and reliable exchange of information between connected devices enables the processing of data to achieve useful results. Moreover, the speed of information delivery is an extremely important factor to the exchange industry. For instance, the ability of a trader to quickly obtain correct pricing information on financial instruments, such as stocks, bonds and particularly options, as quickly as possible cannot be understated. Improvements in information delivery delay on a submitted order of fractions of a second can provide important value to traders. In fact, trading participants always also have a huge need of instantly available market information, which is also known as market data. Thus, and in an attempt to promptly process financial information, or market data, a variety of market data platforms have been developed for the purpose of ostensible “real time” reception of streaming bid, offer, and trade information for financial instruments to traders. Typically a stream of financial data messages are transmitted from the exchanges themselves (e.g. NASDAQ, etc.) over private data communication lines to connected, external, devices of traders.

To this context, the financial data message stream comprises a series of messages that individually represent a new offer to buy or sell a financial instrument, an indication of a completed sale of a financial instrument, notifications of corrections to previously-reported sales of a financial instrument, administrative messages related to such transactions, and the like. And, the term “financial instruments” is used herein in a broad sense and encompasses any tradable item i.e. securities, derivative or commodity, such as stocks, bonds, cash, swaps, futures, foreign exchange, options, gas electricity and so forth, or group of items that is traded through matching of counterparty orders (bid, offer).

Modern financial exchanges provide updates to their members on the changing status of the market place, by providing streams of messages about events, called a market data feed. Markets are growing busier, and the data-rates of these feeds are already in the gigabit range, from which customers must extract and process messages with sub-millisecond latency. However, improvements of prior art systems, utilizing reconfigurable logic, such as Field Programmable Gate Arrays (FPGAs) to process streaming financial information at hardware speeds have been related to either submission of order data and/or reception and processing of already created market data. As should be noted, prior art systems relate to so called trading platforms; e.g. platforms used to create data to be able to trade on an exchange. To this context, it should be noted that a trading platform is not to be equated with an exchange matching platform, which is sometimes referred to as an automated electronic exchange and operated by an exchange operator; e.g. the NASDAQ exchange which is operated by the NASDAQ OMX Group Inc.

### SUMMARY

It is with respect to above considerations and others that the various embodiments of the present invention have been made. It is therefore a general object of embodiments of the present invention to improve upon existing automated exchanges and to provide improved solutions that operate with fewer drawbacks than pre-existing automated exchanges and/or solutions. This object is addressed by the present invention as set out in the appended independent claims. Thus, is disclosed a matching engine data message stream generator of an automated electronic exchange platform. The matching engine data message stream generator comprises a first communications interface which is created on a reconfigurable logic device and configured to receive at least one matching engine message of source specific format from a matching engine of the automated electronic exchange platform. Based on a set of pre-defined conditions, the first communications interface of the matching engine data message stream generator is configured to filter out and discard matching engine messages of source specific format. The matching engine data message stream generator further includes a data message memory buffer created on said reconfigurable logic device and configured to store un-discarded matching engine messages of source specific format. The matching engine data message stream generator moreover includes a firmware logic, deployed on the reconfigurable logic device, and configured to convert the stored matching engine data message of source specific format into a market data message of standardized market data message protocol format, and to generate, from the converted matching engine data messages of standardized market data message protocol format, a stream of market data messages having standardized market data protocol format. The matching engine data message stream generator further includes a second communications interface created on the reconfigurable logic device and configured to transmit the stream of converted market data messages.

In yet a further embodiment a computer-implemented method of generating a market data message stream is disclosed. The computer-implemented method includes receiving, via a first communications interface of a reconfigurable logic device, at least one message of source specific format from a matching engine of said automated electronic exchange platform. Followed by filtering out and discarding, by the first communications interface, source specific matching engine messages based on a set of pre-defined conditions. After filtering un-discarded matching engine messages of source specific format, storing in a data message memory buffer of the reconfigurable logic device. Then, converting by a firmware logic deployed on the reconfigurable logic device, the stored matching engine message of source specific format into a market data message of a standardized market data message protocol format. Subsequently, generating, by the firmware logic, from the converted matching engine messages, a stream of market data messages having standardized market data protocol format and transmitting, by a second communications interface of said reconfigurable logic device, the generated stream of converted market data messages having said standardized market data protocol format.

Yet further advantageous embodiments are recited in the appended dependent claims.

### BRIEF DESCRIPTION OF THE DRAWINGS

Embodiments of the present invention will now be described in more detail, by non-limiting examples and with reference to the accompanying drawings, in which:

FIG. 1 illustrates a typical automated electronic exchange and its inter-connected clients.

FIG. 2 illustrates a block diagram depicting a typical automated electronic exchange platform;

FIG. 3 is a block diagram of exemplary embodiments of present invention.

### DETAILED DESCRIPTION

In the following description, for purposes of explanation and not limitation, specific details are set forth such as particular architectures, interfaces, techniques, etc. in order to provide a thorough understanding of conceived embodiments of the present invention. Like reference numbers refer to like elements or method steps throughout the description.

In short, an aim with embodiments of the present invention is to provide a novel and, also, improved matching engine data message stream generator of an automated exchange platform.

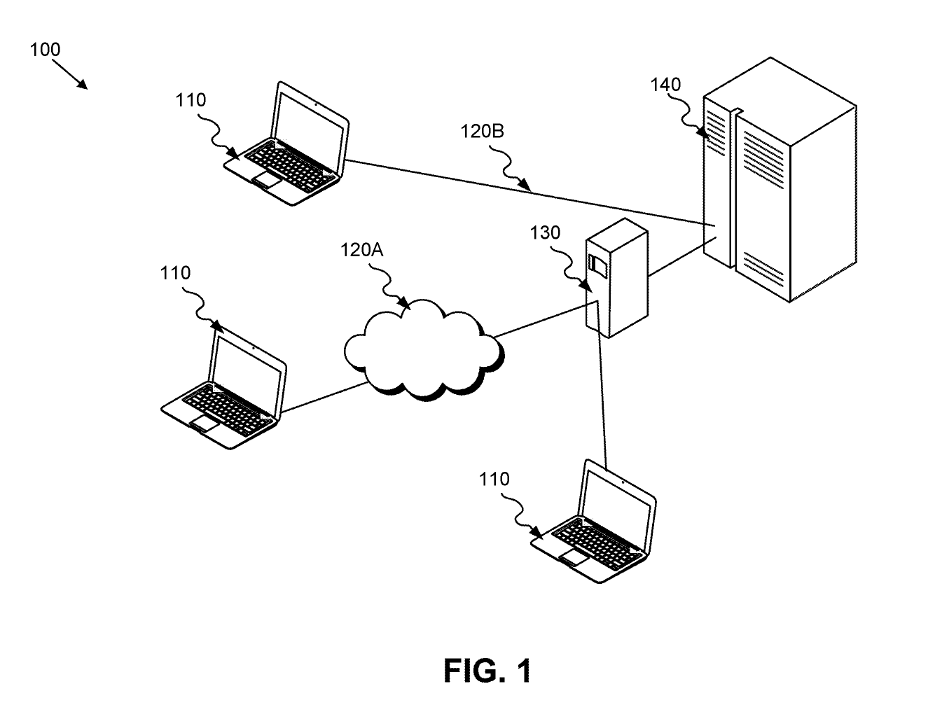

FIG. 1 illustrates an example automated exchange system 100 comprising computers in the form of trader terminals 110 that are used for issuing order data messages (herein also referred to as orders only), i.e. input data received by an automated exchange 140. The computers 110 are connectable, for example over the internet 120, or over some other connection means like a dedicated fiber 120B, to an electronic marketplace, e.g. the automated exchange 140. The automated exchange 140 can be hosted on a computer server or a cluster of computer servers. Sometimes, but not always, the computers 110 are connected to the automated exchange 140 through an entry gateway 130. The entry gateway 130 is connected to, or is being a part of, the automated exchange 140 and is configured to receive market actions, i.e. orders and/or quotes from the trader terminal/computer 110. An entry gateway 130 is usually in connection with the automated exchange 140 on a dedicated network and forwards the market actions to the automated exchange 140 and further usually transmit updates back to the trader terminals/computers 110. It should however be understood that information being communicated to and from the automated exchange 140 and the trader terminals/computers 110 could be communicated via a single communication path. While the trading terminals/computers 110 in FIG. 1 are illustrated as computers that traditionally are associated with manual input of market actions, these can also be implemented as algorithmic trading units, sometimes termed automatic order generators, having manual input means for control of the algorithmic trading unit. The algorithmic trading unit is typically pre-programmed with instructions to automatically generate sell and buy orders and quotes (or changes/cancellations thereof) in response to input data received from the automated exchange 140. The trading terminals/computers 110 also represent trading participants inputting quotes to the automated exchange 140.

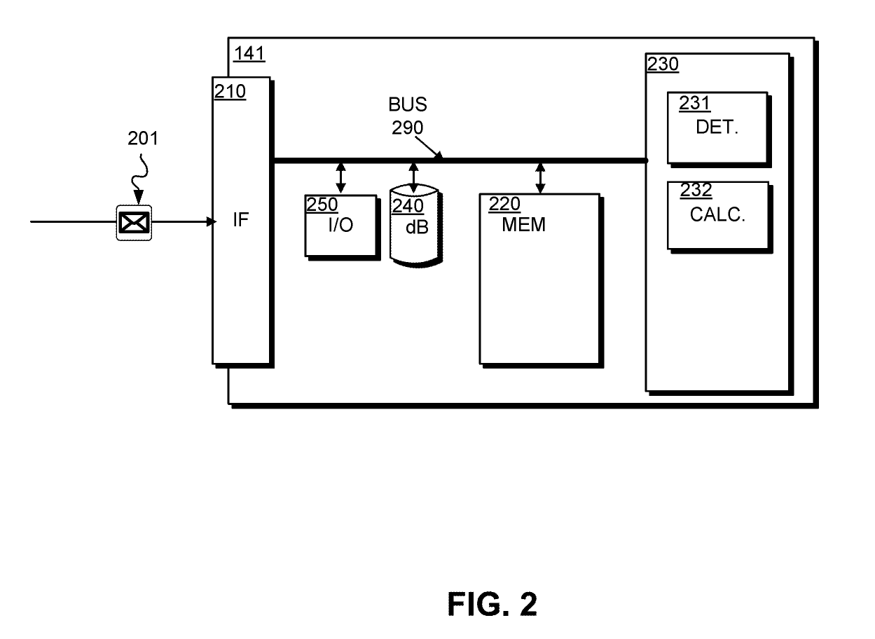

FIG. 2 illustrates a typical matching engine 141 of an automated exchange 140. In said example embodiment, the matching engine 141 is configured for trading of any finacial product. The matching engine 141 may be implemented as part of the automated electronic exhange 140. The matching engine 141 may be hosted on a computer server, or a cluster of computer servers. The matching engine 141 comprises a processing logic 230, or processing logic circuitry. The matching engine 141 additionally typically comprises a memory 220 (e.g. a random access memory, RAM, or another non-volatile storage means), a storage memory 240 (e.g. a hard drive) and an input/output (I/O) controller 250, all coupled by a bus 290. The processing logic 230 may include a processor, microprocessor, an ASIC, FPGA, or the like. In some embodiments, the processing logic 230 may be implemented by a determination module 231 and a calculator module 232. The matching engine 141 is configured to receive messages 201, i.e. a data message from a trading terminal/computer 110, optionally via a gateway 130. The trading terminal/computer 110 comprises processing logic 111, or processing logic circuitry. Furthermore, the trading terminal/computer 110 may additionally comprise a communication interface (not illustrated) with transmission (Tx) and/or reception (Rx) capabilities. To this end, the communication interface can be implemented as a transmitter, a receiver, or a combination of a transmitter and a receiver (i.e. a transceiver). In some embodiments, the modules, components and interfaces discussed with reference to FIG. 2 can be implemented by hardware components, software components or a combination of hardware and software components.

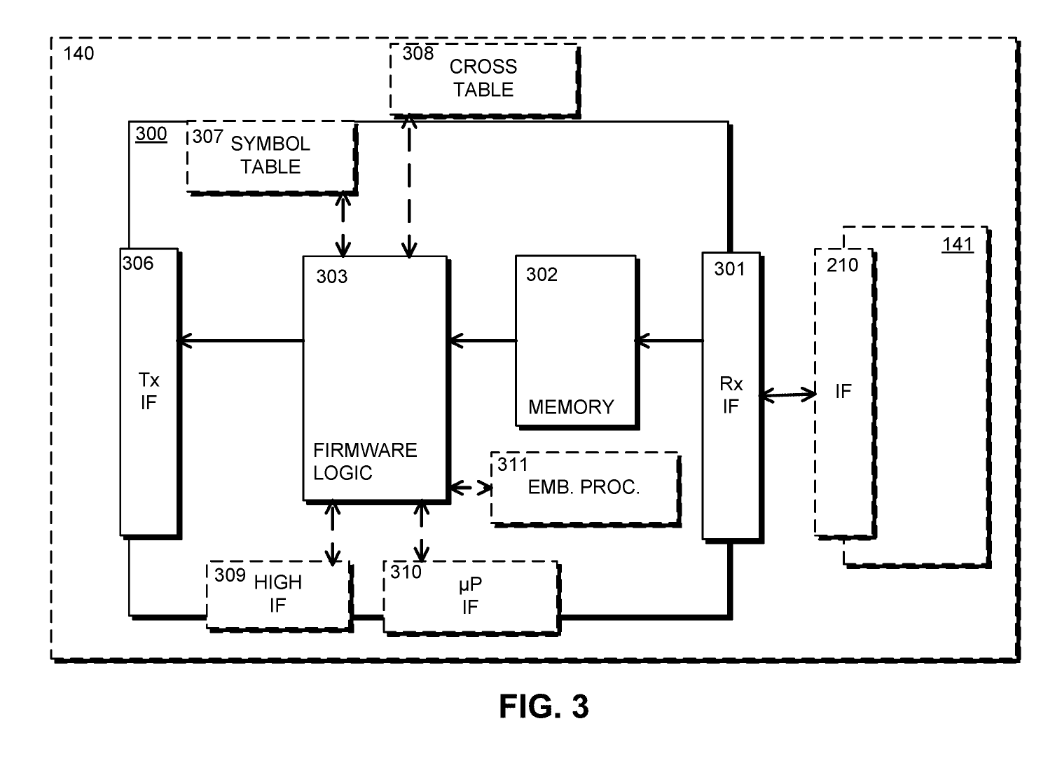

An example embodiment of present invention, which is designed to accelerate financial trading through custom hardware and software, consists of a high speed circuit board, custom Integrated Circuit chips and custom driver and application software. FIG. 3 depicts an example embodiment of present invention and includes a financial market data message stream generator 300 constructed in reconfigurable logic and residing in an automated electronic exchange platform 140. Embodiments of this invention provide a many fold increase in market data speed over existing solutions.

In the detailed description with respect to FIG. 3, for purposes of explanation and not limitation, specific details are set forth in order to provide a thorough understanding of this example implementation. In some instances, detailed descriptions of well-known circuits, components and/or modules have been omitted so as not to obscure the description of the example with unnecessary detail. In the disclosed system, the financial market data message stream generator 300 is connected to a matching engine 141 of the automated electronic exchange platform 140 and comprises a reconfigurable logic device. In a preferred embodiment the financial data message stream generator 300 and the automated electronic exchange 140 are situated in close physical vicinity of each other to avoid latency issues.

The reconfigurable logic of the financial matching engine, or market data, message stream generator 300 contains all the custom hardware for market data acceleration and which logic circuitry can be changed, or reconfigured, remotely as system requirements change. The reconfigurable logic includes a first communications interface 301 that is configured to receive, from said matching engine 141, a message indicating the state of the matching engine has changed for a particular financial instrument. In short, the financial matching engine data message stream generator 300 receives, via the first communications interface 301, data messages that are created by the matching engine 141 of the automated electronic exchange 140. These data messages are received via a communication network, internal to the automated electronic exchange platform 140, and are encapsulated in several source (i.e. exchange platform) specific communication protocols. As appropriate, these specific communications protocols are translated into market data protocols that are suitable for direct transmission to exchange members 110 (i.e. traders/broker etcetera) without further refinement.

The first communications interface 301 is further configured to filter out and remove the above mentioned source specific communication protocols, as well as data messages assessed to be irrelevant for the purposes of market data dissemination to exchange members, based on a set of pre-defined conditions. In other words, data messages that are not of interest for the purpose of market data dissemination are discarded by a reconfigurable filtering logic of the financial matching engine data message stream generator 300. Typically, the market data to be transmitted consists of a series of data messages.

The configurable matching engine data message stream generator 300 further includes a data message memory buffer 302 that is configured to store un-discarded source specific market data messages. Moreover, the matching engine data message stream generator 300 also comprises a firmware logic 303 which is deployed on the reconfigurable logic of the matching engine data message stream generator 300. The firmware logic 303 of the reconfigurable logic device 300 is configured to convert, from the stored source specific matching engine messages of the message stream memory buffer 302, the matching engine messages of source specific format into a market data message of standardized market data message protocol format. The matching engine data message stream generator 300 further includes a second communications interface 306 that is configured to transmit the stream of converted messages of said standardized market data protocol format via a communications network to exchange members.

In aforementioned embodiments, single messages received by the first communications interface 301 are either filtered-out and discarded and then placed in a data message memory buffer 302 for subsequent aggregation of data. However, various embodiments include transmitting the converted message directly, without aggregation. Moreover, in some embodiments of the invention, the firmware logic 303 of the financial market data message stream generator 300 is used to process the matching engine communication protocols, and in doing so retrieve and place messages in memory and use a unique algorithm that results in considerable performance gains.

In yet further embodiments, the financial matching engine data message stream generator 300 generates a data feed, where the data is converted to comply with the NASDAQ OMX proprietary market data protocol ITCH. Which data feed is made up of a series of sequenced messages. Each message is variable in length based on the message type. The ITCH feed can moreover be transmitted as an anonymous market-by-order feed, composed of a series of messages that describe orders added to, removed from, and executed on the automated electronic exchange platform 140. The ITCH feed may also contain messages for basic reference data of order books of the exchange platform, as well as state changes and halts in operation. Or, phrased differently, the financial matching engine data message stream generator 300 encapsulates the generated messages in a communication protocol required by the market data feed communication network. The encapsulated message frames are transmitted, or broadcasted, to market data subscribing customers of the automated electronic exchange platform 140.

In various embodiments of the invention, the matching engine, or market data, message stream generator 300 removes single data messages from the memory buffer and processes these to generate a message format required by the market data stream; e.g. a series of sequenced messages.

In yet further embodiments, the matching engine data message stream generator 300 creates and maintains tables 307, 308 that are needed to filter and process incoming data messages. In some embodiments of the invention, a Symbol Table 307 is created and which symbol table 307 contains a list of valid stock symbols (also known as tickers) and other parameters that the matching engine data message stream generator 300 uses to filter out irrelevant data messages and to generate market data messages of a standardized protocol format. The generation of the contents of the Symbol Table 307 is based and on information from certain incoming data messages and executed by the firmware logic 303. In yet further embodiments of the invention an Order Table is created and maintained. The Order Table keeps track of data messages including all open orders on all valid symbols. The Order Table is generated and constantly modified based on incoming messages. The matching engine data message stream generator 300 also generates and maintains tables 308 for opening and closing crosses as well as for IPO and halt crosses. These tables 308 contain ask and bid data for all symbols participating in a cross. When the cross occurs for a symbol the matching engine data message stream generator 300 must generate market data messages for non-crossed orders and interleave them with the messages generated from the normal incoming messages. The Symbol Table 307 is maintained within the matching engine data message stream generator 300 while the Order and Cross Tables 308 are implemented in high speed memories outside the matching engine data message stream generator 300, in some embodiments these tables are created on the same printed circuit board as the matching engine data message stream generator 300.

In some embodiments the reconfigurable logic device 300 is realized by a Field Programmable Gate Array (FPGA). In yet further embodiments of the invention, the design of the matching engine data message stream generator 300 includes custom high speed interfaces 309 to memories. The custom design of the memory interfaces 309 is unique and results in performance gains. In further embodiments, the matching engine data message stream generator 300 includes an embedded processor 311 including subsystems for initialization, administration, control, status monitoring and communication with the server board.

Present invention may be embodied in other specific forms without departing from its spirit or essential characteristics. The described embodiments are to be considered in all respects only as illustrative and not restrictive. Accordingly, although the present invention has been described above with reference to specific embodiments, it is not intended to be limited to the specific form set forth herein. Rather, the invention is limited only by the accompanying claims and other embodiments than the specific above are equally possible within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality. Still further, reference signs in the claims are provided merely as a clarifying example and should not be construed as limiting the scope of the claims in any way. Also, all statements herein reciting principles, aspects, and embodiments disclosed herein, as well as specific examples thereof, are intended to encompass both structural and functional equivalents thereof. Thus, for example, it will be appreciated by those skilled in the art that block diagrams herein can represent conceptual views of illustrative circuitry or other functional units embodying the principles of the embodiments. Similarly, it will be appreciated that any flow charts and the like represent various processes which may be substantially represented in computer readable medium and so executed by a computer or processor, whether or not such computer or processor is explicitly shown. The functions of the various elements including functional blocks may be provided through the use of hardware such as circuit hardware and/or hardware capable of executing software in the form of coded instructions stored on computer readable medium. Thus, such functions and illustrated functional blocks are to be understood as being hardware-implemented and/or computer-implemented, and thus machine-implemented.

We claim:

1. A market data message stream generator of an automated electronic exchange platform comprising:
a first communications interface created on a reconfigurable logic device and configured to
receive at least one matching engine message of source specific format from a matching engine of said automated electronic exchange platform, and
filter out and discard matching engine messages of source specific format based on a set of pre-defined conditions;
a data message memory buffer created on said reconfigurable logic device and configured to store un-discarded matching engine messages of source specific format;
a firmware logic, deployed on the reconfigurable logic device, and configured to
convert the stored matching engine data message of source specific format into a market data message of standardized market data message protocol format, and
generate, from the converted matching engine data messages of standardized market data message protocol format, a stream of market data messages having standardized market data protocol format; and
a second communications interface created on the reconfigurable logic device and configured to transmit the stream of converted market data messages.

2. The market data message stream generator of claim 1 wherein the market data message stream generator further comprising:
a first table created on the reconfigurable logic device configured to store a list of parameters and symbols for financial instruments of respective matching engine message of source specific format, which parameters and symbols the market data message stream generator subsequently uses to generate the stream of market data messages.

3. The market data message stream generator of claim 1 further comprising:
a high speed communication interface created on the reconfigurable logic device and configured to access a high speed memory device external to the market data message stream generator.

4. The market data message stream generator of claim 1, wherein the first communications interface further configured to transmit market data messages of said standardized format.

5. The market data message stream generator of claim 1 further comprising:
a second communications interface created on said reconfigurable logic device and configured to communicate with an external processor.

6. The market data message stream generator of claim 1 further comprising:
an embedded processor sub-system created on said reconfigurable logic device and configured to
initialize, administer, control, monitor status of the market data message stream generator; and
communicate with an external processor via said second communications interface.

7. The market data message stream generator of claim 1, wherein the market data message stream generator is a Field Programmable Gate Array device.

8. A computer-implemented method of generating a market data message stream comprising:
receiving, via a first communications interface of a reconfigurable logic device, at least one message of source specific format from a matching engine of said automated electronic exchange platform;
filtering out and discarding, by the first communications interface, source specific matching engine messages based on a set of pre-defined conditions;
storing, by a data message memory buffer of said reconfigurable logic device, un-discarded matching engine messages of source specific format;
converting, by a firmware logic deployed on the reconfigurable logic device, the stored matching engine message of source specific format into a market data message of a standardized market data message protocol format;
generating, by the firmware logic, from the converted matching engine messages, a stream of market data messages having standardized market data protocol format; and
transmitting, by a second communications interface of said reconfigurable logic device, the generated stream of converted market data messages having said standardized market data protocol format.

9. The computer-implemented method of claim 8 further comprising:
storing, by a symbol table of the reconfigurable logic device, a list of parameters and symbols for financial instruments of respective matching engine message of source specific format, which parameters and symbols the reconfigurable logic subsequently use in generating the stream of market data messages.

10. The computer-implemented method of claim 8 further comprising:
accessing, via a high speed communication interface of the reconfigurable logic device, a high speed memory device external to the reconfigurable logic device.

11. The computer-implemented method of claim 8 further comprising:
transmitting, via the first communications interface of said reconfigurable logic device, market data messages of said standardized format.

12. The computer-implemented method of claim 8 further comprising:
communicating, via a second communications interface of said reconfigurable logic device, with an external processor.

13. The computer-implemented method of claim 8 further comprising:
initializing, by an embedded processor sub-system of the reconfigurable logic device, controls and status monitors and
communicating, via said second communications interface of the reconfigurable logic device, between the embedded processor sub-system and the external processor.
